(19) United States
(12) Patent Application Publication
(10) Pub. No.: US 2026/0118108 A1
(43) Pub. Date: Apr. 30, 2026

(54) Underground Pipeline Mapping and Inspection Using Frequency Domain Electromagnetic Device

(71) Applicant: ChampionX LLC, Sugar Land, TX (US)

(72) Inventor: Billy Todd Harris, Hearne, TX (US)

(21) Appl. No.: 19/189,978

(22) Filed: Apr. 25, 2025

Related U.S. Application Data
(60) Provisional application No. 63/639,412, filed on Apr. 26, 2024.

(51) Int. Cl. G01B 7/008; B64D 47/00; B64U 20/80

(52) U.S. Cl. CPC G01B 7/008; B64D 47/00; B64U 20/80

(57) ABSTRACT

Underground pipeline mapping and inspection utilizes phase shifts and voltages of electromagnetic signals transmitted to and received from the underground pipeline to determine any displacement of the underground pipeline.

### CROSS REFERENCE TO RELATED APPLICATIONS

This application is a non-provisional patent application claiming the benefit of, and priority to, U.S. Provisional Ser. No. 63/639,412 , filed Apr. 26, 2024, which is incorporated by reference herein in its entirety.

### FIELD OF THE DISCLOSURE

The present disclosure generally relates to the inspection of underground pipeline, and more particularly to determining a displacement of the underground pipeline utilizing an aerial vehicle having a frequency domain electromagnetic device.

### BACKGROUND

Underground pipelines that contain power or communication cables, or that supply materials from one location to another, are ubiquitous. For example, by some estimates there are 2 to 3 million miles of underground natural gas pipelines in the United States. Displacement of a portion of an underground pipeline can occur for various reasons, such as an extreme weather event (e.g., hurricane, tornado, flooding), a geological event (e.g., earthquake, landslide, avalanche), or terrorism (e.g., human-caused explosions).

The location and position of pipelines are inspected for operational and maintenance purposes, and for regulatory purposes as well.

One solution for underground pipeline displacement determination is to use a device that is used for pipeline mapping-referred to as an inertial mapping pig. Inertial mapping pigs have equipment that can determine a position of the pig while the pig moves through the inside of the pipeline from one location to another, the position of the pig being the position of the pipeline since the pig is inside the pipeline. Mapping pigs could be repurposed to also be used for inspection to determine displacement, but the pipeline must be emptied to run the pig and each pig is expensive. Running a single pig through hundreds or thousands of miles of pipeline is not feasible on a time basis, and running multiple pigs through hundreds or thousands of miles of pipeline to minimize the inspection time can be cost prohibitive. Moreover, the pig's movement is limited by the pipeline integrity. For example, if a pipeline if dented or bent by a triggering event so as to prevent the pig from passing through the inside of the pipeline at a certain point, then the pig must travel back the path already traveled and may not be able to access the remainder of the pipeline—losing time and potentially the ability to map the rest of the pipeline.

There is a need for a less expensive and quicker way to map and inspect pipelines to determine pipeline displacement without having to shut down the pipeline.

### SUMMARY

A method for inspecting an underground pipeline can include: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a phase shift or a voltage peak of a phase shift between the first electromagnetic signal sensed by the receiver and a second electromagnetic signal transmitted to the underground pipeline by a transmitter during inducing the inspection current; determining an inspection Z-coordinate (inspection depth) of the underground pipeline based on the phase shift or the voltage peak of the phase shift; and determining a displacement of the underground pipeline by comparing the inspection Z-coordinate (inspection depth) of the underground pipeline with a reference Z coordinate (reference depth) of the underground pipeline.

Another method for inspecting an underground pipeline can include: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a voltage peak of a phase shift between the first electromagnetic signal sensed by the receiver and a second electromagnetic signal transmitted to the underground pipeline by a transmitter during inducing the inspection current; determining an inspection X-Y coordinate position of the receiver of the FDED relative to the surface of the Earth corresponding to when the voltage peak is identified; determining an inspection Z-coordinate of the underground pipeline based on the voltage peak; determining an inspection X-Y-Z coordinate position of the underground pipeline based on the inspection Z-coordinate of the underground pipeline and the inspection X-Y coordinate position of the receiver; and determining a displacement of the underground pipeline by comparing the inspection X-Y-Z coordinate position of the underground pipeline with a reference X-Y-Z coordinate position of the underground pipeline.

A method for mapping an underground pipeline, comprising: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a voltage peak of a phase shift between the first electromagnetic signal sensed by the receiver and a second electromagnetic signal transmitted to the underground pipeline by a transmitter during inducing the inspection current; determining a mapping depth (a reference Z-coordinate) of the underground pipeline based on the phase shift, the voltage peak, or both the phase shift and the voltage peak.

Another method for mapping an underground pipeline can include: positioning the receiver of the FDED above the surface of the Earth; inducing a mapping current in the underground pipeline, wherein the mapping current equals the inspection current; while inducing the mapping current, wirelessly sensing, by the receiver of the FDED, a third electromagnetic signal from the underground pipeline; identifying a voltage peak of a phase shift between the third electromagnetic signal sensed by the receiver and a fourth electromagnetic signal transmitted to the underground pipeline by the transmitter during inducing the mapping current; determining the reference X-Y coordinate position of the receiver of the FDED relative to the surface of the Earth corresponding to when the voltage peak is identified; determining a reference Z-coordinate of the underground pipeline based on the voltage peak; and determining the reference X-Y-Z coordinate position of the underground pipeline based on the reference Z-coordinate of the underground pipeline and the reference X-Y coordinate position of the receiver.

An apparatus including: an aerial vehicle; and a frequency domain electromagnetic device (FDED) attached to the aerial vehicle, wherein the FDED includes a receiver and a computer operably connected to the receiver; wherein the aerial vehicle positions the receiver at a height above a surface of the Earth, wherein an underground pipeline lies at a depth below the surface of the Earth above which the receiver is positioned; wherein the FDED: while an inspection current is induced in the underground pipeline, wirelessly senses, by the receiver, a first electromagnetic signal from the underground pipeline; identifies, by the computer, a phase shift or a voltage peak of a phase shift between the first electromagnetic signal sensed by the receiver and a second electromagnetic signal transmitted to the underground pipeline to induce the inspection current; determines, by the computer, an inspection Z-coordinate of the underground pipeline based on the phase shift or voltage peak; and determines, by the computer, a displacement of the underground pipeline by comparing the inspection Z-coordinate of the underground pipeline with a reference Z-coordinate of the underground pipeline.

An apparatus can include: an aerial vehicle; and a frequency domain electromagnetic device (FDED) attached to the aerial vehicle, wherein the FDED includes: a transmitter loop coupled to the aerial vehicle; a transmitter housing coupled to the transmitter loop, wherein the transmitter housing includes a signal generator operably connected to the transmitter loop; a receiver housing coupled to the transmitter housing, wherein the receiver housing includes a receiver loop; a computer operably connected to the receiver loop and to the transmitter loop; and a geographic position device operably connected to the computer; wherein the receiver loop is positioned in a receiver plane that is below and parallel to a transmitter plane in which the transmitter loop is positioned. The FDED transmits an electromagnetic signal to the underground pipeline, senses another electromagnetic signal from the pipeline, and determines a phase shift between the signals and in some cases, also determines the voltage of the phase shift. The peak voltage is indicative of at least the depth of the pipeline. The apparatus has the functionality of any combination of the apparatus functions described herein.

A frequency domain electromagnetic device (FDED) can include: a transmitter loop; a transmitter housing coupled to the transmitter loop, wherein the transmitter housing includes a signal generator operably connected to the transmitter loop; a receiver housing coupled to the transmitter housing, wherein the receiver housing includes a receiver loop; a computer operably connected to the receiver loop and to the transmitter loop; and a geographic position device operably connected to the computer; wherein the receiver loop is positioned in a receiver plane that is below and parallel to a transmitter plane in which the transmitter loop is positioned. The FDED transmits an electromagnetic signal to the underground pipeline, senses another electromagnetic signal from the pipeline, and determines a phase shift between the signals and in some cases, also determines the voltage of the phase shift. The peak voltage is indicative of at least the depth of the pipeline.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an embodiment of the disclosed apparatus for mapping and inspection of a location of an underground pipeline using a frequency domain electromagnetic device.

FIG. 2 illustrates another embodiment of the disclosed apparatus for mapping and inspection of a location of an underground pipeline using a frequency domain electromagnetic device.

FIG. 3 illustrates a top view of an underground pipeline, with an exemplary mapping and inspection path drawn thereon.

FIG. 4 is a graph of phase shift versus distance for metal pipes buried at 1 inch, 2 inches, and 6 inches below a surface.

FIG. 5 is a graph of voltage versus distance, where the voltage is for the phase shift in FIG. 4, and the distance is the same distance of FIG. 4.

### DETAILED DESCRIPTION

“Frequency domain” as used herein refers to the use of a constant frequency for electromagnetic signals, such as a frequency in a range of from 10 kHz to 50 kHz.

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15.

Disclosed herein are apparatus, devices, and methods for mapping and inspection of the location of an underground pipeline, to determine if any displacement of any portion or section of the pipeline has occurred relative to a prior determination of the pipeline location. The techniques utilize the transmission and receipt of electromatic signals to and from the underground pipeline. It has been found that the phase shift and the voltage of the phase shift between these transmitted and received signals is indicative of the location of the section or portion of the buried pipeline that is below the frequency domain electromagnetic device of this disclosure. An initial assessment of the location of portions of an underground pipeline can be made by moving the apparatus and device through a mapping path that establishes a reference location (e.g., reference X-Y-Z coordinates) of each portion of the pipeline to which subsequent determination of inspection locations (e.g., inspection X-Y-Z coordinates) of those portions of the pipeline can be compared to determine if displacement of any portion of the underground pipeline has occurred. Later inspection locations can then become the reference locations to which further later inspection locations can be compared.

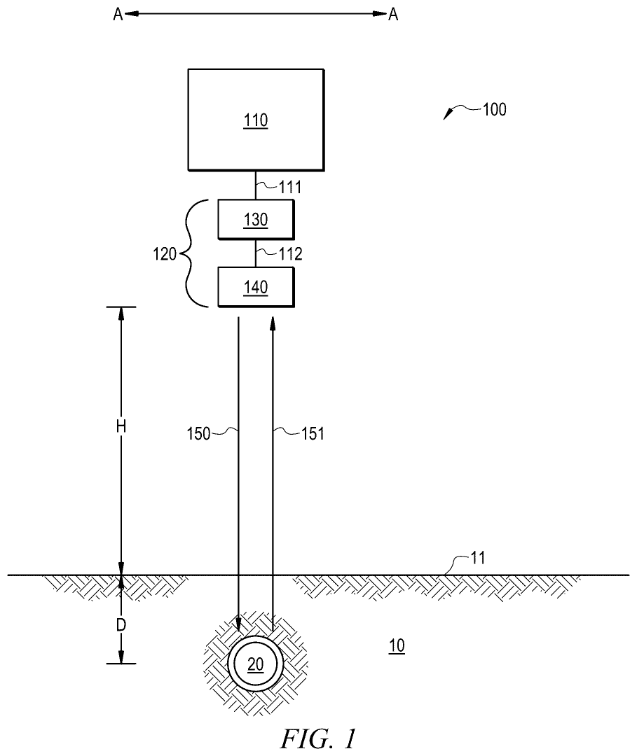

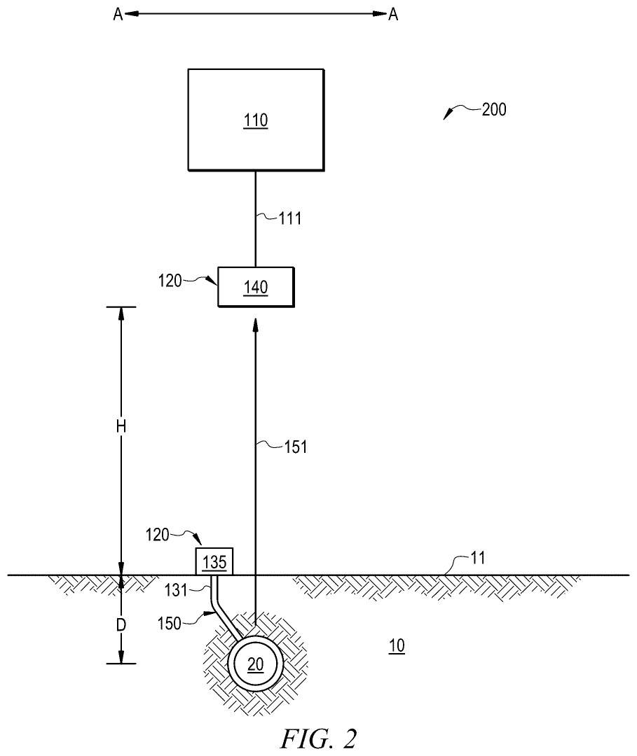

FIGS. 1 and 2 illustrate embodiments of the disclosed apparatus 100 and 200 for mapping and inspection of a location of an underground pipeline 20 using a frequency domain electromagnetic device (FDED) 120. The underground pipeline 20 is not drawn to scale and is not limited in diameter or length by this disclosure, and can be of any size and length. The FDED 120 is positioned at a height H above the surface 11 of the Earth 10. The height H can be a predetermined height the enables electromagnetic signals to be sensed by the FDED 120 according to the techniques disclosed herein, for example, 1, 2, 3, 4, 5, 6, 7, 8, 9, 10, 11, or 12 feet. The pipeline 20 is buried underground below a surface 11 of the Earth 10. The depth D of the pipeline 20 can be any depth known in the art of buried pipelines, such as, and without limitation, 1, 2, 3, 4, 5, 6, 7, 8, 9, 10, 11, or 12 inches, or 1, 2, 3, 4, 5, 6, 7, 8, 9, or 10 ft.

Referring to FIG. 1, the apparatus 100 includes an aerial vehicle 110 and the frequency domain electromagnetic device (FDED) 120.

The aerial vehicle 110 is configured to position the receiver 140 of the FDED 120 at a height H above a surface 11 of the Earth 10 where an underground pipeline 20 lies at a depth D below the surface of the Earth above which the receiver loop is positioned. The aerial vehicle 110 moves the FDED 120 along a flight path above the pipeline 20, including in the direction of double arrow A-A, which is a direction that is perpendicular to the longitudinal axis of the pipeline 20. The aerial vehicle 110 can move the FDED 120 in other directions in combination with the direction of double arrow A-A; however, the electromagnetic signals 150 and 151 are transmitted and received when the aerial vehicle 110 moves in the direction of double arrow A-A.

The aerial vehicle 110 can be any aerial vehicle, whether flown by a pilot or not, including a drone (also known as a unmanned aerial vehicle or UAV), an airplane, or a helicopter. The aerial vehicle 110 has the power and agility to move the FDED 120 on a flight path at a predetermined height H above the surface 11 of the Earth 10 for the time periods required for mapping and inspection of the underground pipeline 20.

At least a portion of the FDED 120 is contained in or attached to the aerial vehicle 110. The FDED 120 includes a transmitter 130 and a receiver 140. In FIG. 1, the transmitter 130 is coupled to the aerial vehicle 110 via connection 111, and the receiver 140 is coupled to the transmitter 130 via connection 112. Each connection 111 and connection 112 can be any type of physical connection such as but not limited to a rigid rod, a strap, a cable, a clamp, adhesive, a bolt, a weld, or a combination thereof. In aspects, the connection 112 can be two rigid rods, each having a diameter of 0.25, 0.5, or 0.75 inches and a height of 4, 5, 6, 7, or 8 inches.

The transmitter 130 can be any transmitter configured to wirelessly transmit an electromagnetic signal 150 to the underground pipeline 20. When the electromagnetic signal 150 contacts the underground pipeline 20, a magnetic flux is created, which causes a current (e.g., an alternating current) to be induced in the underground pipeline 20. The induced current emits an electromagnetic signal 151 from the underground pipeline 20 that can be sensed by the receiver 140 of the FDED 120.

In aspects, the transmitter 130 comprises a transmitter antenna and a signal generator operably connected to the transmitter antenna (e.g., via electrical wiring). In some embodiments, the transmitter antenna is a transmitter loop. The transmitter loop can have an inner diameter in range of from 15 inches to 20 inches, such as 15, 16, 17, 18, 19, or 20 inches; and a height in a range of from 0.5 inch to 2 inches, such as 0.5, 0.75, 1.0, 1.25, 1.5, 1.75, or 2 inches. In aspects, the antenna of the transmitter loop can be made of metal or other electrically conductive metal. The antenna can be contained in an antenna housing such as a loop-shaped housing made of carbon fiber, metal, or plastic. The signal generator of the transmitter 130 can be any electromagnetic signal generator known in the art with the aid of this disclosure. An example of a signal generator is the Model HO52 available under the brand HANMATEK®. The signal generator of the transmitter 130 can be contained in a transmitter housing that is structurally connected to the transmitter loop and to the aerial vehicle 110. In aspects, the transmitter housing can have a diameter in a range of from 4 inches to 7 inches, for example, 4, 5, 6, or 7 inches, and a height in a range of from 5 inches to 15 inches, for example, 5, 6, 7, 8, 9, 10, 11, 12, 13, 14, or 15 inches. The transmitter housing can be made of any material, such as carbon fiber, metal, or a plastic.

The receiver 140 can be any receiver configured to sense an electromagnetic signal 151 from the underground pipeline 20. In aspects, the receiver 140 comprises a receiver antenna configured to sense the current and voltage from the electromagnetic signal 151 emitted by the pipeline 20 when the current is induced in the pipeline 20 by the electromagnetic signal 150 transmitted from the transmitter 130. In aspects, the receiver antenna can be embodied as a receiver loop. In aspects, the antenna of the receiver loop can be made of metal or other electrically conductive metal. The antenna can be enclosed in an antenna housing made of carbon fiber, metal, or plastic. In aspects, the receiver loop can have an inner diameter in a range of from 2 inches to 6 inches, such as 2, 3, 4, 5, or inches; and a height in a range of from 2 inches to 6 inches, such as 2, 3, 4, 5, or 6 inches. In aspects, a diameter of the receiver loop is smaller than a diameter of the transmitter loop. In aspects, the receiver loop and the transmitter loop share a central axis (e.g., share the same longitudinal axis). In aspects, the receiver loop of the receiver 140 can have coils in a range of from 10 to 100 coils, such as 10, 20, 30, 40, 50, 60, 70, 80, 90, or 100 wire coils.

In aspects where the transmitter 130 comprises a transmitter loop and the receiver 140 comprises a receiver loop, the receiver loop can be positioned in a plane that is below and parallel to a plane in which the transmitter loop is positioned. In aspects, the planes can be separated by a distance in a range of from 1 inch to 12 inches, for example, 1, 2, 3, 4, 5, 6, 7, 8, 9, 10, 11, or 12 inches.

The FDED 120 can also include a computer contained in the transmitter 130 (e.g., in the transmitter housing) or the receiver 140 (e.g., in the receiver housing). The computer is operably connected (e.g., via wired connections) to the signal generator of the transmitter 130 so as to receive electrical signals about the electromagnetic signal 150 transmitted from the transmitter 130 and to the receiver antenna of the receiver 140 so as to receive electrical signals about the electromagnetic signal 151 sensed by the receiver 140, convert the electrical signals to data, and log the data. The computer can have one or more processors, memory, and instructions stored on the memory that cause the computer to perform the operations for determining pipeline displacement disclosed herein. An example of a computer in the FDED 120 can be a system-on-module (SOM), such as those available under the brand RASBERRY PI® and having a data acquisition (DAQ) component such as a MCC 118 DAQ HAT. In aspects, the computer can have a sampling frequency in a range of from 10 kHz to 100 kHz, such as 10, 20, 30, 40, 50 60, 70, 80, 90, or 100 kHz. In aspects, the computer can have a sampling resolution of 10, 11, 12, 13, 14, or 15 bits.

The FDED 120 can additionally include a geographic position device communicatively and/or operably connected to the computer of the FDED 120. The geographic position device determines the X-Y coordinate (e.g., latitude and longitude coordinates) of the FDED 120 (e.g., the receiver 140 of the FDED 120). The geographic position device can be configured to send/receive/use global positions system (GPS) or global navigation satellite system (GNSS) signals to determine a geographic location or position of the FDED 120. The geographic position device is configured to output a geographic position signal containing geographic position data to the computer of the FDED 120. In aspects, the geographic position device can send geographic position data to the computer during electromagnetic signal transmission and sensing of the FDED 120 so that the geographic position data can be included with metadata that is associated with the phase shift and voltage data determined from the transmitted and sensed electromagnetic signals 150 and 151. In aspects, the geographic position device can be included in the transmitter 130 (e.g., in the transmitter housing) or in the receiver 140 (e.g., in the receiver housing).

In some aspects, the geographic position device of the FDED 120 can be used to map the location of the underground pipeline 20 for later comparison of the mapped locations as reference to inspection locations, to determine if pipeline displacement has occurred. In particular, the geographic position device can determine the reference X-Y coordinate position of the receiver 140 of the FDED 120 relative to the surface 11 of the Earth 10, including at the time corresponding to when the voltage peak is identified during mapping.

In some aspects, the geographic position device of the FDED 120 can be used for inspection of the underground pipeline 20. In particular, the geographic position device can determine an X-Y coordinate position of the receiver 140 of the FDED 120 relative to the surface 11 of the Earth 10, including at the time corresponding to when the voltage peak is identified during inspection.

In some aspects, the computer of the FDED 120 in apparatus 100 can be used to map the location of the underground pipeline 20 for later comparison of the location as reference to inspection locations, to determine if pipeline displacement has occurred. The computer of the FDED 120 can be used for mapping of the underground pipeline 20, having instructions to cause one or more processors to determine a reference Z-coordinate of the underground pipeline 20. Determining the reference Z-coordinate can include 1) identify a phase shift or a voltage peak of a phase shift between an electromagnetic signal 151 sensed by the receiver 140 and an electromagnetic signal 150 transmitted to the underground pipeline 20 by a transmitter 130 during inducing the inspection current; and 2) determine the reference Z-coordinate of the underground pipeline 20 based on the phase shift or the voltage peak of the phase shift.

In some additional or alternative aspects, the computer of the FDED 120 can be used for mapping of the underground pipeline 20, having instructions to cause one or more processors to determine a reference X-Y-Z coordinate position of the underground pipeline 20. Determining the reference X-Y-Z coordinate position can include 1) identifying a voltage peak of a phase shift between an electromagnetic signal 151 sensed by the receiver 140 and the electromagnetic signal 150 transmitted to the underground pipeline 20 by the transmitter 130 while a mapping current is induced in the pipeline 20, 2) determining a reference Z-coordinate (the reference depth) of the underground pipeline based on the voltage peak, 3) determining the reference X-Y-Z coordinate position of the underground pipeline 20 based on the reference Z-coordinate of the underground pipeline and the reference X-Y coordinate position of the receiver 140.

In some additional or alternative aspects, the computer of the FDED 120 in apparatus 100 can be used to inspect the location of the underground pipeline 20, having instructions to cause one or more processors to 1) identify a phase shift or a voltage peak of a phase shift between the first electromagnetic signal 151 sensed by the receiver 140 and a second electromagnetic signal 150 transmitted to the underground pipeline 20 by a transmitter 130 during inducing the inspection current; 2) determine an inspection Z-coordinate of the underground pipeline 20 based on the phase shift or the voltage peak of the phase shift; and 3) determine a displacement of the underground pipeline 20 by comparing the inspection Z-coordinate of the underground pipeline 20 with a reference Z coordinate of the underground pipeline.

In some additional or alternative aspects, the computer of the FDED 120 in apparatus 100 can be used to inspect the location of the underground pipeline 20, having instructions to cause one or more processors to 1) identify a voltage peak of a phase shift between an electromagnetic signal 151 sensed by the receiver 140 (e.g., receiver loop) and an electromagnetic signal 150 transmitted to the underground pipeline 20 by the transmitter 130 (e.g., transmitter loop) while an inspection current is induced in the underground pipeline 20, 2) determining an inspection Z-coordinate (the inspection depth) of the underground pipeline based on the voltage peak, 3) determining the inspection X-Y-Z coordinate position of the underground pipeline 20 based on the inspection Z-coordinate of the underground pipeline and the inspection X-Y coordinate position of the receiver 140, and 4) determine a displacement of the underground pipeline 20 by comparing the inspection X-Y-Z coordinate position of the underground pipeline 20 with the reference X-Y-Z coordinate position of the underground pipeline 20.

In aspects, the mapping current induced in the underground pipeline 20 is the same amperage as the inspection current induced in the underground pipeline 20.

The apparatus 100 can be used for mapping and inspection the location (or portions) of the underground pipeline 20. For purposed of illustration in FIG. 1, transmitted electromagnetic signal 150 and sensed electromagnetic signal 151 can be the signals for mapping and for inspection techniques disclosed herein.

Referring to FIG. 2, the apparatus 200 includes the aerial vehicle 110 and the frequency domain electromagnetic device (FDED) 120.

The aerial vehicle 110 is configured to position the receiver 140 of the FDED 120 at a height H above a surface 11 of the Earth 10 where an underground pipeline 20 lies at a depth D below the surface of the Earth above which the receiver loop is positioned. The aerial vehicle 110 moves the FDED 120 along a flight path above the pipeline 20, including in the direction of double arrow A-A, which is a direction that is perpendicular to the longitudinal axis of the pipeline 20. The aerial vehicle 110 can move the FDED 120 in other directions in combination with the direction of double arrow A-A; however, the electromagnetic signals 150 and 151 are transmitted and received when the aerial vehicle moves in the direction of double arrow A-A.

The aerial vehicle 110 can be any aerial vehicle connected to the FDED 120; embodiments of the aerial vehicle being described above for the apparatus 100 in FIG. 1.

In the apparatus 200, the FDED 120 includes a transmitter 135 and the receiver 140.

The transmitter 135 is not coupled to the aerial vehicle 110 and is instead positioned on the surface 11 of the Earth and connected to the underground pipeline 20 by an electrical connection 131, such as a wire. The transmitter 135 can be any transmitter configured to transmit an electromagnetic signal 150 to the underground pipeline 20 via electrical connection 131, which causes a current to be induced in the underground pipeline 20, which emits an electromagnetic signal 151 that can be sensed by the receiver 140 of the FDED 120. In aspects, the transmitter 135 comprises a signal generator operably connected to the underground pipe 20 via electrical connection 131. The signal generator of the transmitter 135 can be any electromagnetic signal generator known in the art with the aid of this disclosure. An example of a signal generator is the Model HO52 handheld oscilloscope available under the brand HANMATEK®. The signal generator of the transmitter 135 can be contained in a transmitter housing. In aspects, the transmitter housing in the apparatus 200 of FIG. 2 can have any shape and size to house the signal generator. In aspects, the transmitter housing can be made of any material, such as carbon fiber, metal, or a plastic.

The receiver 140 can be any receiver configured to sense an electromagnetic signal 151 from the underground pipeline 20. In aspects, the receiver 140 comprises a receiver antenna configured to sense the current and voltage from the electromagnetic signal 151 emitted by the pipeline 20 when the current is induced in the pipeline 20 by the electromagnetic signal 150 transmitted from the transmitter 135. In aspects, the receiver antenna can be embodied as a receiver loop. In aspects, the antenna of the receiver loop can be made of metal or other electrically conductive metal. The antenna can be enclosed in an antenna housing made of carbon fiber, metal, or plastic. In aspects, the receiver loop can have an inner diameter in a range of from 2 inches to 6 inches, such as 2, 3, 4, 5, or inches; and a height in a range of from 2 inches to 6 inches, such as 2, 3, 4, 5, or 6 inches. In aspects, a diameter of the receiver loop is smaller than a diameter of the transmitter loop. In aspects, the receiver loop and the transmitter loop share a central axis (e.g., share the same longitudinal axis). In aspects, the receiver loop of the receiver 140 can have coils in a range of from 10 to 100 coils, such as 10, 20, 30, 40, 50, 60, 70, 80, 90, or 100 wire coils.

The apparatus 200 can include two computers, a first computer contained in the transmitter 135 (e.g., in transmitter housing) and a second computer contained in the FDED 120 (e.g., in the receiver 140, for example, in the receiver housing). The first computer is operably connected (e.g., via wired connections) to the signal generator of the transmitter 135 so as to sense the electromagnet signal 150, to convert the signals to data, and log the data. The second computer is operably connected to the receiver antenna of the receiver 140 so as to sense electrical signals (e.g., electromagnetic signal 151) to convert the signals to data, and log the data. Each of the first computer and the second computer can have one or more processors, memory, and instructions stored on the memory that cause the computer to perform the operations for determining pipeline displacement disclosed herein. An example of a computer that can be placed in the transmitter 135 of the apparatus 200 and in the receiver 140 of the FDED 120 can be a system-on-module (SOM), such as those available under the brand RASBERRY PI® and having a data acquisition component such as a MCC 118 DAQ HAT. In aspects, each computer can have a sampling frequency in a range of from 10 kHz to 100 kHz, such as 10, 20, 30, 40, 50 60, 70 80, 90, or 100 kHz. In aspects, the computer can have a sampling resolution of 10, 11, 12, 13, 14, or 15 bits.

In aspects, the computer in the transmitter 135 can wirelessly transmit via a wireless data signal comprising the logged data about the transmitted electromagnetic signal 150 to the receiver 140. The computer in the receiver 140 can receive the wireless data signal from the transmitter 135 and associate the logged data about the transmitted electromagnetic signal 150 with logged data about the sensed electromagnetic signal 151, so as to determine a phase shift and peak voltage as described herein.

The apparatus 200 can also include a geographic position device communicatively and/or operably connected to the second computer contained in the receiver 140 of the FDED 120. The geographic position device determines the X-Y coordinate (e.g., latitude and longitude coordinates) of the FDED 120 (e.g., the receiver 140 of the FDED 120). The geographic position device is configured to output a geographic position signal containing geographic position data to the second computer of the FDED 120 in apparatus 200. The geographic position device in apparatus 200 has the same functionality as described for the geographic position device in apparatus 100.

In some aspects, the computer of the receiver 140 of the FDED 120 can be used to map the location of the underground pipeline 20 for later comparison of the location as reference to inspection locations, to determine if pipeline displacement has occurred. The computer of the receiver 140 of the FDED 120 can have one or more processors, memory, and instructions stored on the memory that can the computer to perform the mapping as described for the computer in FDED 120 in apparatus 100 of FIG. 1.

In some aspects, the computer of the receiver 140 of the FDED 120 can be used for inspection of the underground pipeline 20, having instructions to cause one or more processors to perform the inspection as described for the computer in FDED 120 in apparatus 100 of FIG. 1.

For example, the computer of the FDED 120 in apparatus 200 can be used to map the location of the underground pipeline 20 for later comparison of the location as reference to inspection locations, to determine if pipeline displacement has occurred. The computer of the FDED 120 can be used for mapping of the underground pipeline 20, having instructions to cause one or more processors to determine a reference X-Y-Z coordinate position of the underground pipeline 20. Determining the reference X-Y-Z coordinate position can include 1) identifying a voltage peak of a phase shift between an electromagnetic signal 151 sensed by the receiver 140 and the electromagnetic signal 150 transmitted to the underground pipeline 20 by the transmitter 135 while a mapping current is induced in the pipeline 20, 2) determining a reference Z-coordinate (the reference depth) of the underground pipeline based on the voltage peak, 3) determining the reference X-Y-Z coordinate position of the underground pipeline 20 based on the reference Z-coordinate of the underground pipeline and the reference X-Y coordinate position of the receiver 140.

In some aspects, the computer of the FDED 120 in apparatus 200 can be used for inspection of the underground pipeline 20, having instructions to cause one or more processors to 1) identify a voltage peak of a phase shift between an electromagnetic signal 151 sensed by the receiver 140 (e.g., receiver loop) and an electromagnetic signal 150 transmitted to the underground pipeline 20 by the transmitter 135 (e.g., transmitter loop) while an inspection current is induced in the underground pipeline 20, 2) determining an inspection Z-coordinate (the inspection depth) of the underground pipeline based on the voltage peak, 3) determining the inspection X-Y-Z coordinate position of the underground pipeline 20 based on the inspection Z-coordinate of the underground pipeline and the inspection X-Y coordinate position of the receiver 140, and 4) determine a displacement of the underground pipeline 20 by comparing the inspection X-Y-Z coordinate position of the underground pipeline 20 with the reference X-Y-Z coordinate position of the underground pipeline 20.

In aspects, the mapping current induced in the underground pipeline 20 is the same amperage as the inspection current induced in the underground pipeline 20.

The apparatus 200 can be used for mapping and inspection the location (or portions) of the underground pipeline 20. For purposed of illustration in FIG. 2, transmitted electromagnetic signal 150 and sensed electromagnetic signal 151 can be the signals for mapping and for inspection techniques disclosed herein.

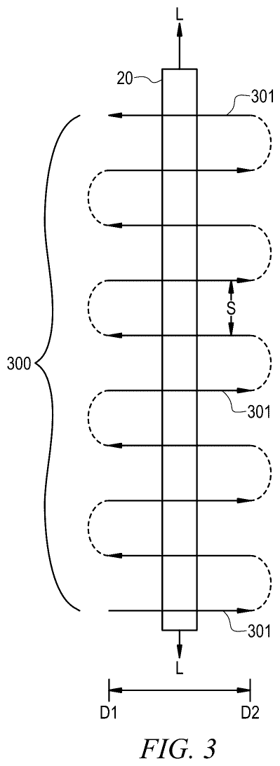

FIG. 3 illustrates a top view of an underground pipeline 20, with an exemplary mapping and inspection path 300 drawn thereon. The path 300 is exemplary only, and the number of turns (dashed curves) and space S between portions of the underground pipeline 20 that are mapped or inspected are not limited by those illustrated in FIG. 3. Moreover, the space S between the portions does not have to be equal among portions and can be different depending on the circumstances.

The path 300 is taken by the aerial vehicle 110 of the apparatus 100 and 200 during mapping and inspection of the underground pipeline 20. The same path 300 is taken for mapping and inspection so that the locations detected during mapping are the same as the locations detected during inspection. Transmission of electromatic signal 150 and sensing of electromagnetic signal 151 occur while the apparatus 100 and 200 is in the solid arrows 301 of the path 300 over distance of D1 to D2 or D2 to D2, depending on direction of travel of the apparatus 100 and 200. Distance D1 to D2 is equal to or greater than the outer diameter of the underground pipeline 20 so that displacement detection can be performed between D1 and D2. Distance Solid arrows 301 of the path 300 are illustrated as being perpendicular to the longitudinal axis L-L of the pipeline 20. Solid arrows 301 are also illustrated as being parallel to one another for the underground pipeline 20 illustrated in FIG. 3; however, it is contemplated that the solid arrows 301 are not parallel to another in some portions of the underground pipeline 20, such as curved portions of the underground pipeline 20.

The voltage peak that is determined according to the techniques herein is generally located at the longitudinal axis L-L of the underground pipeline 20 as the apparatus 100 and 200 is positioned and moves along solid arrows in path 300. The dashed curve lines in path 300 represent the change in direction of the apparatus 100 and 200 for additional mapping and inspection for additional portion(s) of the underground pipeline 20.

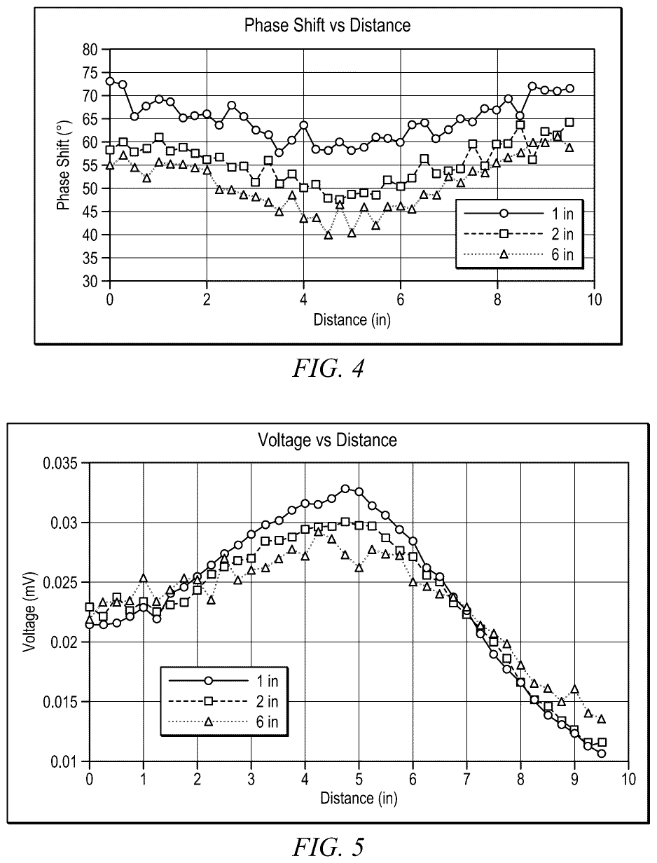

FIG. 4 is a graph of phase shift versus distance for metal pipes buried at 1 inch, 2 inches, and 6 inches below a surface. The phase shift is between the transmitted electromagnetic signal 150 and the sensed electromagnetic signal 151, and the distance is the distance the aerial vehicle 110 travels over the underground pipeline 20 in a direction that is perpendicular to a longitudinal axis L-L of the underground pipeline 20 while the FDED 120 detects the electromagnetic signals 150 and 151. As can be seen, the deeper the underground pipeline 20 is buried, the lower the phase shift values. The minimum value of the phase shift during a measurement is indicative of the depth of the underground pipeline 20, with smaller values in multiple phase shift curves being indicative of a greater depth than larger values in multiple phase shift curves. In FIG. 4, the lowest phase shift values are indicative of the location of the longitudinal axis of the underground pipeline 20. Thus, phase shift values, and in particular, phase shift value minimums, can be used to determine the depth D, referred to herein as Z-coordinate, of the underground pipeline 20.

FIG. 5 is a graph of voltage versus distance, where the voltage is for the phase shift in FIG. 4, and the distance is the same distance of FIG. 4. As can be seen, the deeper the underground pipeline 20 is buried, the higher the voltage, so the value of the voltage is indicative of the depth D of the underground pipeline 20, with larger values being indicative of a greater depth than smaller values. In FIG. 5, the highest voltage values (the peak voltages) are indicative of the location of the longitudinal axis of the underground pipeline 20. Thus, voltage values, and in particular peak voltage values, can be used to determine the depth D, referred to herein as Z-coordinate, of the underground pipeline 20.

Comparing the curves in FIG. 4 and FIG. 5, while both phase shift and voltages can help indicate pipeline depth D, it appears that peak voltage data has less noise than phase shift data.

Also disclosed herein are methods for mapping and inspecting underground pipelines to determine whether or not displacement in any portion of the underground pipeline has occurred.

A method for inspecting an underground pipeline 20 can include positioning the receiver 140 of the FDED 120 at a height H above a surface 11 of the Earth 10; inducing an inspection current in the underground pipeline 20; while inducing the inspection current, wirelessly sensing, by the receiver 140 of the FDED 120, a first electromagnetic signal 151 from the underground pipeline 20; identifying a voltage peak of a phase shift between the first electromagnetic signal 151 sensed by the receiver 140 and a second electromagnetic signal 150 transmitted to the underground pipeline 20 by a transmitter 130/135 during inducing the inspection current; determining an inspection X-Y coordinate position of the receiver 140 of the FDED 120 relative to the surface 11 of the Earth 10 corresponding to when or where the voltage peak is identified; determining an inspection Z-coordinate of the underground pipeline 20 based on the voltage peak; determining an inspection X-Y-Z coordinate position of the underground pipeline 20 based on the inspection Z-coordinate of the underground pipeline 20 and the inspection X-Y coordinate position of the receiver 140; and determining a displacement of the underground pipeline 20 by comparing the inspection X-Y-Z coordinate position of the underground pipeline 20 with a reference X-Y-Z coordinate position of the underground pipeline 20.

In the method, inducing the inspection current in the underground pipeline 20 can include wirelessly transmitting, by the transmitter 130 that is coupled to the aerial vehicle 110, the second electromagnetic signal 150 to the underground pipeline 20, wherein the second electromagnetic signal 150 induces the inspection current in the underground pipeline 20. Alternatively in the method, the transmitter 135 is electrically connected to the underground pipeline 20, and inducing the inspection current in the underground pipeline 20 can include transmitting, by the transmitter 135 via the electrical connection 131 to the underground pipeline 20, the second electromagnetic signal 150 to the underground pipeline 20, wherein the second electromagnetic signal 150 induces the inspection current in the underground pipeline 20.

The method can also include determining the reference X-Y-Z coordinate position of the underground pipeline 20. In aspects, determining the reference X-Y-Z coordinate position of the underground pipeline 20 can include positioning the receiver 140 of the FDED 120 above the surface 11 of the Earth 10; inducing a mapping current in the underground pipeline 20, wherein the mapping current equals the inspection current; while inducing the mapping current, wirelessly sensing, by the receiver 140 of the FDED 120, a third electromagnetic signal 151 from the underground pipeline; identifying a voltage peak of a phase shift between the third electromagnetic signal 151 sensed by the receiver and a fourth electromagnetic signal 150 transmitted to the underground pipeline 20 by the transmitter 130/135 during inducing the mapping current; determining the reference X-Y coordinate position of the receiver 140 of the FDED 120 relative to the surface 11 of the Earth 10 corresponding to when the voltage peak is identified; determining a reference Z-coordinate of the underground pipeline 20 based on the voltage peak; and determining the reference X-Y-Z coordinate position of the underground pipeline 20 based on the reference Z-coordinate of the underground pipeline 20 and the reference X-Y coordinate position of the receiver 140.

In some aspects of the method, identifying a voltage peak of a phase shift between the third electromagnetic signal 151 sensed by the receiver 140 and the fourth electromagnetic signal 150 transmitted to the underground pipeline 20 by the transmitter 130/135 during inducing the mapping current is performed by a computer of the FDED 120; determining the reference X-Y coordinate position of the receiver 140 of the FDED 120 relative to the surface 11 of the Earth 10 corresponding to when the voltage peak is identified is performed by a geographic position device of the FDED 120; determining the reference Z-coordinate of the underground pipeline 20 based on the voltage peak is performed by the computer of the FDED 120; and determining the reference X-Y-Z coordinate position of the underground pipeline 20 based on the reference Z-coordinate of the underground pipeline 20 and the reference X-Y coordinate position of the receiver 140 is performed by the computer of the FDED 120.

In some aspects of the method, identifying the voltage peak of the phase shift is performed by a computer of the FDED 120; determining the inspection X-Y coordinate position of the receiver 140 of the FDED 120 is performed by a geographic position device of the FDED 120; determining the inspection Z-coordinate of the underground pipeline 20 based on the voltage peak is performed by the computer of the FDED 120; determining the inspection X-Y-Z coordinate position of the underground pipeline 20 is performed by the computer of the FDED 120; and determining the displacement of the underground pipeline 20 is performed by the computer of the FDED 120.

The method can also include determining the reference X-Y-Z coordinate position of the underground pipeline 20. In aspects, determining the reference X-Y-Z coordinate position of the underground pipeline 20 can include positioning the receiver 140 of the FDED 120 above the surface 11 of the Earth 10; inducing a mapping current in the underground pipeline 10, wherein the mapping current equals the inspection current; while inducing the mapping current, wirelessly sensing, by the receiver 140 of the FDED 120, a third electromagnetic signal 151 from the underground pipeline 20; identifying a voltage peak of a phase shift between the third electromagnetic signal 151 sensed by the receiver and a fourth electromagnetic signal 150 transmitted to the underground pipeline 20 by the transmitter 130/135 during inducing the mapping current; determining the reference X-Y coordinate position of the receiver 140 of the FDED 120 relative to the surface 11 of the Earth 10 corresponding to when the voltage peak is identified; determining a reference Z-coordinate of the underground pipeline 20 based on the voltage peak; and determining the reference X-Y-Z coordinate position of the underground pipeline 20 based on the reference Z-coordinate of the underground pipeline 20 and the reference X-Y coordinate position of the receiver 140.

A method for mapping an underground pipeline 20 can include: positioning the receiver 140 of the FDED 120 above the surface 11 of the Earth 10; inducing a mapping current in the underground pipeline 10, wherein the mapping current equals the inspection current; while inducing the mapping current, wirelessly sensing, by the receiver 140 of the FDED 120, a third electromagnetic signal 151 from the underground pipeline 20; identifying a voltage peak of a phase shift between the third electromagnetic signal 151 sensed by the receiver 140 and a fourth electromagnetic signal 150 transmitted to the underground pipeline 20 by the transmitter 130/135 during inducing the mapping current; determining the reference X-Y coordinate position of the receiver 140 of the FDED 120 relative to the surface 11 of the Earth 10 corresponding to when the voltage peak is identified; determining a reference Z-coordinate of the underground pipeline 20 based on the voltage peak; and determining the reference X-Y-Z coordinate position of the underground pipeline 20 based on the reference Z-coordinate of the underground pipeline 20 and the reference X-Y coordinate position of the receiver 140.

In some aspects, identifying a voltage peak of a phase shift between the third electromagnetic signal 151 sensed by the receiver 140 and the fourth electromagnetic signal 150 transmitted to the underground pipeline 20 by the transmitter 130/135 during inducing the mapping current is performed by a computer of the FDED 120; determining the reference X-Y coordinate position of the receiver 140 of the FDED 120 relative to the surface 11 of the Earth 10 corresponding to when the voltage peak is identified is performed by a geographic position device of the FDED 120; determining the reference Z-coordinate of the underground pipeline 20 based on the voltage peak is performed by the computer of the FDED 120; and determining the reference X-Y-Z coordinate position of the underground pipeline 20 based on the reference Z-coordinate of the underground pipeline 20 and the reference X-Y coordinate position of the receiver 140 is performed by the computer of the FDED 120.

### Additional Aspects

Aspect 1. A method for inspecting an underground pipeline, comprising: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a voltage peak of a phase shift between the first electromagnetic signal sensed by the receiver and a second electromagnetic signal transmitted to the underground pipeline by a transmitter during inducing the inspection current; determining an inspection X-Y coordinate position of the receiver of the FDED relative to the surface of the Earth corresponding to when the voltage peak is identified; determining an inspection Z-coordinate of the underground pipeline based on the voltage peak; determining an inspection X-Y-Z coordinate position of the underground pipeline based on the inspection Z-coordinate of the underground pipeline and the inspection X-Y coordinate position of the receiver; and determining a displacement of the underground pipeline by comparing the inspection X-Y-Z coordinate position of the underground pipeline with a reference X-Y-Z coordinate position of the underground pipeline.

Aspect 2. The method of Aspect 1, wherein inducing the inspection current in the underground pipeline comprises: wirelessly transmitting, by the transmitter, the second electromagnetic signal to the underground pipeline, wherein the second electromagnetic signal induces the inspection current in the underground pipeline.

Aspect 3. The method of Aspect 1, wherein the transmitter is connected to the underground pipeline, wherein inducing the inspection current in the underground pipeline comprises: transmitting, by the transmitter via a wired connection or a direct connection to the underground pipeline, the second electromagnetic signal to the underground pipeline, wherein the second electromagnetic signal induces the inspection current in the underground pipeline.

Aspect 4. The method of Aspect 1, wherein the transmitter is a transmitter loop.

Aspect 5. The method of Aspect 4, wherein the receiver is a receiver loop, wherein a diameter of the receiver loop is smaller than a diameter of the transmitter loop.

Aspect 6. The method of Aspect 5, wherein the receiver loop is positioned in a receiver plane that is below and parallel to a transmitter plane in which the transmitter loop is positioned.

Aspect 7. The method of Aspect 1, wherein the FDED is contained in or attached to an aerial vehicle comprising a drone, an airplane, or a helicopter.

Aspect 8. The method of Aspect 1, further comprising: determining the reference X-Y-Z coordinate position of the underground pipeline.

Aspect 9. The method of Aspect 8, wherein determining the reference X-Y-Z coordinate position of the underground pipeline comprises: positioning the receiver of the FDED above the surface of the Earth; inducing a mapping current in the underground pipeline, wherein the mapping current equals the inspection current; while inducing the mapping current, wirelessly sensing, by the receiver of the FDED, a third electromagnetic signal from the underground pipeline; identifying a voltage peak of a phase shift between the third electromagnetic signal sensed by the receiver and a fourth electromagnetic signal transmitted to the underground pipeline by the transmitter during inducing the mapping current; determining the reference X-Y coordinate position of the receiver of the FDED relative to the surface of the Earth corresponding to when the voltage peak is identified; determining a reference Z-coordinate of the underground pipeline based on the voltage peak; and determining the reference X-Y-Z coordinate position of the underground pipeline based on the reference Z-coordinate of the underground pipeline and the reference X-Y coordinate position of the receiver.

Aspect 10. The method of Aspect 9, wherein: identifying a voltage peak of a phase shift between the third electromagnetic signal sensed by the receiver and the fourth electromagnetic signal transmitted to the underground pipeline by the transmitter during inducing the mapping current is performed by a computer of the FDED; determining the reference X-Y coordinate position of the receiver of the FDED relative to the surface of the Earth corresponding to when the voltage peak is identified is performed by a geographic position device of the FDED; determining the reference Z-coordinate of the underground pipeline based on the voltage peak is performed by the computer of the FDED; and determining the reference X-Y-Z coordinate position of the underground pipeline based on the reference Z-coordinate of the underground pipeline and the reference X-Y coordinate position of the receiver is performed by the computer of the FDED.

Aspect 11. The method of Aspect 1, wherein: identifying the voltage peak of the phase shift is performed by a computer of the FDED; determining the inspection X-Y coordinate position of the receiver of the FDED is performed by a geographic position device of the FDED; determining the inspection Z-coordinate of the underground pipeline based on the voltage peak is performed by the computer of the FDED; determining the inspection X-Y-Z coordinate position of the underground pipeline is performed by the computer of the FDED; and determining the displacement of the underground pipeline is performed by the computer of the FDED.

Aspect 12. An apparatus comprising: an aerial vehicle; and a frequency domain electromagnetic device (FDED) attached to the aerial vehicle, wherein the FDED comprises: a transmitter loop coupled to the aerial vehicle; a transmitter housing coupled to the transmitter loop, wherein the transmitter housing comprises a signal generator operably connected to the transmitter loop; a receiver housing coupled to the transmitter housing, wherein the receiver housing comprises a receiver loop; a computer operably connected to the receiver loop and to the transmitter loop; and a geographic position device operably connected to the computer; wherein the receiver loop is positioned in a receiver plane that is below and parallel to a transmitter plane in which the transmitter loop is positioned.

Aspect 13. The apparatus of Aspect 12, wherein a diameter of the receiver loop is smaller than a diameter of the transmitter loop.

Aspect 14. The apparatus of Aspect 13, wherein the receiver loop and the transmitter loop share a central axis.

Aspect 15. The apparatus of Aspect 12, wherein the receiver housing is coupled to the transmitter housing by at least one rigid rod.

Aspect 16. The apparatus of Aspect 15, wherein the receiver housing is coupled to the transmitter housing by two rigid rods.

Aspect 17. The apparatus of Aspect 12, wherein the aerial vehicle positions the receiver loop at a height above a surface of the Earth, wherein an underground pipeline lies at a depth below the surface of the Earth above which the receiver loop is positioned; wherein the FDED: induces, by the transmitter loop, an inspection current in the underground pipeline; while inducing the inspection current, wirelessly senses, by the receiver loop, a first electromagnetic signal from the underground pipeline; identifies, by the computer, a voltage peak of a phase shift between the first electromagnetic signal sensed by the receiver loop and a second electromagnetic signal transmitted to the underground pipeline by the transmitter loop during inducing the inspection current; determines, by the geographic position device, an inspection X-Y coordinate position of the receiver loop relative to the surface of the Earth corresponding to when the voltage peak is identified; determines, by the computer, a Z-coordinate of the underground pipeline based on the voltage peak; determines, by the computer, an inspection X-Y-Z coordinate position of the underground pipeline based on the Z-coordinate of the underground pipeline and the inspection X-Y coordinate position of the receiver loop; and determines, by the computer, a displacement of the underground pipeline by comparing the inspection X-Y-Z coordinate position of the underground pipeline with a reference X-Y-Z coordinate position of the underground pipeline.

Aspect 18. The apparatus of Aspect 17, wherein the FDED determines the reference X-Y-Z coordinate position of the underground pipeline.

Aspect 19. The apparatus of Aspect 18, wherein, to determine the reference X-Y-Z coordinate position of the underground pipeline, the apparatus: positions, by the aerial vehicle, the receiver loop above the surface of the Earth; induces, by the transmitter loop, a mapping current in the underground pipeline, wherein the mapping current equals the inspection current; while inducing the mapping current, wirelessly senses, by the receiver loop, a third electromagnetic signal from the underground pipeline; identifies, by the computer, a voltage peak of a phase shift between the third electromagnetic signal sensed by the receiver and a fourth electromagnetic signal transmitted to the underground pipeline by the transmitter loop during inducing the mapping current; determines, by the geographic position device, the reference X-Y coordinate position of the receiver of the FDED relative to the surface of the Earth corresponding to when the voltage peak is identified; determines, by the computer, a reference Z-coordinate of the underground pipeline based on the voltage peak; and determines, by the computer, the reference X-Y-Z coordinate position of the underground pipeline based on the reference Z-coordinate and the reference X-Y coordinate position of the receiver.

Aspect 20. The apparatus of Aspect 12, wherein the aerial vehicle comprises a drone, an airplane, or a helicopter.

Aspect 21. A frequency domain electromagnetic device (FDED) can include: a transmitter loop; a transmitter housing coupled to the transmitter loop, wherein the transmitter housing includes a signal generator operably connected to the transmitter loop; a receiver housing coupled to the transmitter housing, wherein the receiver housing includes a receiver loop; a computer operably connected to the receiver loop and to the transmitter loop; and a geographic position device operably connected to the computer; wherein the receiver loop is positioned in a receiver plane that is below and parallel to a transmitter plane in which the transmitter loop is positioned. The FDED transmits an electromagnetic signal to the underground pipeline, senses another electromagnetic signal from the pipeline, and determines a phase shift between the signals and in some cases, also determines the voltage of the phase shift. The peak voltage is indicative of at least the depth of the pipeline.

Aspect 22. A method for mapping an underground pipeline can include: positioning the receiver of the FDED above the surface of the Earth; inducing a mapping current in the underground pipeline, wherein the mapping current equals the inspection current; while inducing the mapping current, wirelessly sensing, by the receiver of the FDED, a third electromagnetic signal from the underground pipeline; identifying a voltage peak of a phase shift between the third electromagnetic signal sensed by the receiver and a fourth electromagnetic signal transmitted to the underground pipeline by the transmitter during inducing the mapping current; determining the reference X-Y coordinate position of the receiver of the FDED relative to the surface of the Earth corresponding to when the voltage peak is identified; determining a reference Z-coordinate of the underground pipeline based on the voltage peak; and determining the reference X-Y-Z coordinate position of the underground pipeline based on the reference Z-coordinate of the underground pipeline and the reference X-Y coordinate position of the receiver.

Aspect 23. A method for inspecting an underground pipeline, comprising: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a voltage peak of a phase shift between the first electromagnetic signal sensed by the receiver and a second electromagnetic signal transmitted to the underground pipeline by a transmitter during inducing the inspection current; determining an inspection depth (an inspection Z-coordinate) of the underground pipeline based on the phase shift, the voltage peak, or both the phase shift and the voltage peak; and determining a displacement of the underground pipeline by comparing the inspection Z-coordinate of the underground pipeline with a reference Z-coordinate of the underground pipeline.

Aspect 23. A method for mapping an underground pipeline, comprising: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a voltage peak of a phase shift between the first electromagnetic signal sensed by the receiver and a second electromagnetic signal transmitted to the underground pipeline by a transmitter during inducing the inspection current; determining a mapping depth (a reference Z-coordinate) of the underground pipeline based on the phase shift, the voltage peak, or both the phase shift and the voltage peak.

Clause 1. A method for inspecting an underground pipeline, comprising: positioning a receiver of a frequency domain electromagnetic device (FDED) at a height above a surface of the Earth, wherein the underground pipeline lies at a depth below the surface of the Earth above which the receiver of the FDED is positioned; inducing an inspection current in the underground pipeline; while inducing the inspection current, wirelessly sensing, by the receiver of the FDED, a first electromagnetic signal from the underground pipeline; identifying a phase shift or a voltage peak of a phase shift between the first electromagnetic signal sensed by the receiver and a second electromagnetic signal transmitted to the underground pipeline by a transmitter during inducing the inspection current; determining an inspection Z-coordinate of the underground pipeline based on the phase shift or the voltage peak of the phase shift; and determining a displacement of the underground pipeline by comparing the inspection Z-coordinate of the underground pipeline with a reference Z coordinate of the underground pipeline.

Clause 2. The method of clause 1, further comprising: determining an inspection X-Y coordinate position of the receiver of the FDED relative to the surface of the Earth corresponding to when the voltage peak is identified; and determining an inspection X-Y-Z coordinate position of the underground pipeline based on the inspection Z-coordinate of the underground pipeline and the inspection X-Y coordinate position of the receiver; wherein determining the displacement of the underground pipeline further includes comparing the inspection X-Y-Z coordinate position of the underground pipeline with a reference X-Y-Z coordinate position of the underground pipeline.

Clause 3. The method of clause 1, wherein inducing the inspection current in the underground pipeline comprises: wirelessly transmitting, by the transmitter, the second electromagnetic signal to the underground pipeline, wherein the second electromagnetic signal induces the inspection current in the underground pipeline.

Clause 4. The method of clause 1, wherein the transmitter is connected to the underground pipeline, wherein inducing the inspection current in the underground pipeline comprises: transmitting, by the transmitter via a wired connection or a direct connection to the underground pipeline, the second electromagnetic signal to the underground pipeline, wherein the second electromagnetic signal induces the inspection current in the underground pipeline.

Clause 5. The method of clause 1, wherein the transmitter is a transmitter loop.

Clause 6. The method of clause 5, wherein the receiver is a receiver loop, wherein a diameter of the receiver loop is smaller than a diameter of the transmitter loop.

Clause 7. The method of clause 6, wherein the receiver loop is positioned in a receiver plane that is below and parallel to a transmitter plane in which the transmitter loop is positioned.

Clause 8. The method of clause 1, wherein the FDED is contained in or attached to an aerial vehicle comprising a drone, an airplane, or a helicopter.

Clause 9. The method of clause 1, further comprising: determining the reference Z-coordinate of the underground pipeline.

Clause 10. The method of clause 9, wherein determining the reference Z-coordinate of the underground pipeline comprises: positioning the receiver of the FDED above the surface of the Earth; inducing a mapping current in the underground pipeline, wherein the mapping current equals the inspection current; while inducing the mapping current, wirelessly sensing, by the receiver of the FDED, a third electromagnetic signal from the underground pipeline; identifying a phase shift or a voltage peak of a phase shift between the third electromagnetic signal sensed by the receiver and a fourth electromagnetic signal transmitted to the underground pipeline by the transmitter during inducing the mapping current; and determining the reference Z-coordinate of the underground pipeline based on the phase shift or the voltage peak.

Clause 11. The method of clause 10, further comprising: determining a reference X-Y coordinate position of the receiver of the FDED relative to the surface of the Earth corresponding to when the voltage peak is identified; and determining a reference X-Y-Z coordinate position of the underground pipeline based on the reference Z-coordinate of the underground pipeline and the reference X-Y coordinate position of the receiver.

Clause 12. An apparatus comprising: an aerial vehicle; and a frequency domain electromagnetic device (FDED) attached to the aerial vehicle, wherein the FDED comprises a receiver and a computer operably connected to the receiver; wherein the aerial vehicle positions the receiver at a height above a surface of the Earth, wherein an underground pipeline lies at a depth below the surface of the Earth above which the receiver is positioned; wherein the FDED: while an inspection current is induced in the underground pipeline, wirelessly senses, by the receiver, a first electromagnetic signal from the underground pipeline; identifies, by the computer, a phase shift or a voltage peak of a phase shift between the first electromagnetic signal sensed by the receiver and a second electromagnetic signal transmitted to the underground pipeline to induce the inspection current; determines, by the computer, an inspection Z-coordinate of the underground pipeline based on the phase shift or voltage peak; and determines, by the computer, a displacement of the underground pipeline by comparing the inspection Z-coordinate of the underground pipeline with a reference Z-coordinate of the underground pipeline.

Clause 13. The apparatus of clause 12, wherein the receiver comprises a receiver loop, wherein the FDED further comprises: a transmitter loop coupled to the aerial vehicle; and a transmitter housing coupled to the transmitter loop, wherein the transmitter housing comprises a signal generator operably connected to the transmitter loop; wherein a diameter of the receiver loop is smaller than a diameter of the transmitter loop; and wherein the receiver loop is positioned in a receiver plane that is below and parallel to a transmitter plane in which the transmitter loop is positioned.

Clause 14. The apparatus of clause 13, wherein the receiver loop and the transmitter loop share a central axis.

Clause 15. The apparatus of clause 13, wherein the receiver housing is coupled to the transmitter housing by at least one rigid rod.

Clause 16. The apparatus of clause 15, wherein the receiver housing is coupled to the transmitter housing by two rigid rods.

Clause 17. The apparatus of clause 13, wherein the FDED: induces, by the transmitter loop, the inspection current in the underground pipeline; determines, by a geographic position device of the FDED, an inspection X-Y coordinate position of the receiver relative to the surface of the Earth corresponding to when the voltage peak is identified; and determines, by the computer, an inspection X-Y-Z coordinate position of the underground pipeline based on the Z-coordinate of the underground pipeline and the inspection X-Y coordinate position of the receiver loop; wherein the displacement is determined, by the computer, further by comparing the inspection X-Y-Z coordinate position of the underground pipeline with a reference X-Y-Z coordinate position of the underground pipeline.

Clause 18. The apparatus of clause 17, wherein the FDED determines the reference X-Y-Z coordinate position of the underground pipeline.

Clause 19. The apparatus of clause 18, wherein, to determine the reference X-Y-Z coordinate position of the underground pipeline, the apparatus: positions, by the aerial vehicle, the receiver loop above the surface of the Earth; induces, by the transmitter loop, a mapping current in the underground pipeline, wherein the mapping current equals the inspection current; while inducing the mapping current, wirelessly senses, by the receiver loop, a third electromagnetic signal from the underground pipeline; identifies, by the computer, a voltage peak of a phase shift between the third electromagnetic signal sensed by the receiver and a fourth electromagnetic signal transmitted to the underground pipeline by the transmitter loop during inducing the mapping current; determines, by the geographic position device, the reference X-Y coordinate position of the receiver of the FDED relative to the surface of the Earth corresponding to when the voltage peak is identified; determines, by the computer, a reference Z-coordinate of the underground pipeline based on the voltage peak; and determines, by the computer, the reference X-Y-Z coordinate position of the underground pipeline based on the reference Z-coordinate and the reference X-Y coordinate position of the receiver.

Clause 20. The apparatus of clause 12, wherein the aerial vehicle comprises a drone, an airplane, or a helicopter.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for inspecting an underground pipeline, comprising:
positioning a receiver of a frequency domain electromagnetic device (FDED) at a height above a surface of the Earth, wherein the underground pipeline lies at a depth below the surface of the Earth above which the receiver of the FDED is positioned;
inducing an inspection current in the underground pipeline;
while inducing the inspection current, wirelessly sensing, by the receiver of the FDED, a first electromagnetic signal from the underground pipeline;
identifying a phase shift or a voltage peak of a phase shift between the first electromagnetic signal sensed by the receiver and a second electromagnetic signal transmitted to the underground pipeline by a transmitter during inducing the inspection current;
determining an inspection Z-coordinate of the underground pipeline based on the phase shift or the voltage peak of the phase shift; and
determining a displacement of the underground pipeline by comparing the inspection Z-coordinate of the underground pipeline with a reference Z coordinate of the underground pipeline.

2. The method of claim 1, further comprising:
determining an inspection X-Y coordinate position of the receiver of the FDED relative to the surface of the Earth corresponding to when the voltage peak is identified; and
determining an inspection X-Y-Z coordinate position of the underground pipeline based on the inspection Z-coordinate of the underground pipeline and the inspection X-Y coordinate position of the receiver;
wherein determining the displacement of the underground pipeline further includes comparing the inspection X-Y-Z coordinate position of the underground pipeline with a reference X-Y-Z coordinate position of the underground pipeline.

3. The method of claim 1, wherein inducing the inspection current in the underground pipeline comprises:
wirelessly transmitting, by the transmitter, the second electromagnetic signal to the underground pipeline, wherein the second electromagnetic signal induces the inspection current in the underground pipeline.

4. The method of claim 1, wherein the transmitter is connected to the underground pipeline, wherein inducing the inspection current in the underground pipeline comprises:
transmitting, by the transmitter via a wired connection or a direct connection to the underground pipeline, the second electromagnetic signal to the underground pipeline, wherein the second electromagnetic signal induces the inspection current in the underground pipeline.

5. The method of claim 1, wherein the transmitter is a transmitter loop.

6. The method of claim 5, wherein the receiver is a receiver loop, wherein a diameter of the receiver loop is smaller than a diameter of the transmitter loop.

7. The method of claim 6, wherein the receiver loop is positioned in a receiver plane that is below and parallel to a transmitter plane in which the transmitter loop is positioned.

8. The method of claim 1, wherein the FDED is contained in or attached to an aerial vehicle comprising a drone, an airplane, or a helicopter.

9. The method of claim 1, further comprising:
determining the reference Z-coordinate of the underground pipeline.

10. The method of claim 9, wherein determining the reference Z-coordinate of the underground pipeline comprises:
positioning the receiver of the FDED above the surface of the Earth;
inducing a mapping current in the underground pipeline, wherein the mapping current equals the inspection current;
while inducing the mapping current, wirelessly sensing, by the receiver of the FDED, a third electromagnetic signal from the underground pipeline;
identifying a phase shift or a voltage peak of a phase shift between the third electromagnetic signal sensed by the receiver and a fourth electromagnetic signal transmitted to the underground pipeline by the transmitter during inducing the mapping current; and
determining the reference Z-coordinate of the underground pipeline based on the phase shift or the voltage peak.

11. The method of claim 10, further comprising:
determining a reference X-Y coordinate position of the receiver of the FDED relative to the surface of the Earth corresponding to when the voltage peak is identified; and
determining a reference X-Y-Z coordinate position of the underground pipeline based on the reference Z-coordinate of the underground pipeline and the reference X-Y coordinate position of the receiver.

12. An apparatus comprising:
an aerial vehicle; and
a frequency domain electromagnetic device (FDED) attached to the aerial vehicle, wherein the FDED comprises a receiver and a computer operably connected to the receiver;
wherein the aerial vehicle positions the receiver at a height above a surface of the Earth, wherein an underground pipeline lies at a depth below the surface of the Earth above which the receiver is positioned;
wherein the FDED:
while an inspection current is induced in the underground pipeline, wirelessly senses, by the receiver, a first electromagnetic signal from the underground pipeline;
identifies, by the computer, a phase shift or a voltage peak of a phase shift between the first electromagnetic signal sensed by the receiver and a second electromagnetic signal transmitted to the underground pipeline to induce the inspection current;
determines, by the computer, an inspection Z-coordinate of the underground pipeline based on the phase shift or voltage peak; and
determines, by the computer, a displacement of the underground pipeline by comparing the inspection Z-coordinate of the underground pipeline with a reference Z-coordinate of the underground pipeline.

13. The apparatus of claim 12, wherein the receiver comprises a receiver loop, wherein the FDED further comprises:
a transmitter loop coupled to the aerial vehicle; and
a transmitter housing coupled to the transmitter loop, wherein the transmitter housing comprises a signal generator operably connected to the transmitter loop;
wherein a diameter of the receiver loop is smaller than a diameter of the transmitter loop; and
wherein the receiver loop is positioned in a receiver plane that is below and parallel to a transmitter plane in which the transmitter loop is positioned.

14. The apparatus of claim 13, wherein the receiver loop and the transmitter loop share a central axis.

15. The apparatus of claim 13, wherein the receiver housing is coupled to the transmitter housing by at least one rigid rod.

16. The apparatus of claim 15, wherein the receiver housing is coupled to the transmitter housing by two rigid rods.

17. The apparatus of claim 13,
wherein the FDED:
induces, by the transmitter loop, the inspection current in the underground pipeline;
determines, by a geographic position device of the FDED, an inspection X-Y coordinate position of the receiver relative to the surface of the Earth corresponding to when the voltage peak is identified; and
determines, by the computer, an inspection X-Y-Z coordinate position of the underground pipeline based on the Z-coordinate of the underground pipeline and the inspection X-Y coordinate position of the receiver loop;
wherein the displacement is determined, by the computer, further by comparing the inspection X-Y-Z coordinate position of the underground pipeline with a reference X-Y-Z coordinate position of the underground pipeline.

18. The apparatus of claim 17, wherein the FDED determines the reference X-Y-Z coordinate position of the underground pipeline.

19. The apparatus of claim 18, wherein, to determine the reference X-Y-Z coordinate position of the underground pipeline, the apparatus:
positions, by the aerial vehicle, the receiver loop above the surface of the Earth;
induces, by the transmitter loop, a mapping current in the underground pipeline, wherein the mapping current equals the inspection current;
while inducing the mapping current, wirelessly senses, by the receiver loop, a third electromagnetic signal from the underground pipeline;
identifies, by the computer, a voltage peak of a phase shift between the third electromagnetic signal sensed by the receiver and a fourth electromagnetic signal transmitted to the underground pipeline by the transmitter loop during inducing the mapping current;
determines, by the geographic position device, the reference X-Y coordinate position of the receiver of the FDED relative to the surface of the Earth corresponding to when the voltage peak is identified;
determines, by the computer, a reference Z-coordinate of the underground pipeline based on the voltage peak; and
determines, by the computer, the reference X-Y-Z coordinate position of the underground pipeline based on the reference Z-coordinate and the reference X-Y coordinate position of the receiver.

20. The apparatus of claim 12, wherein the aerial vehicle comprises a drone, an airplane, or a helicopter.
